(19) United States
(12) Patent Application Publication
(10) Pub. No.: US 2025/0379492 A1
(43) Pub. Date: Dec. 11, 2025

(54) Electric cut-off machine with a battery and multiple operating modes

(71) Applicant: Andreas Stihl AG & Co. KG, Waiblingen (DE)

(72) Inventors: Alexander Haas, Spraitbach (DE); Sebastian Renz, Gomaringen (DE); Denis Ehrler, Wernau (DE); Tobias Wagner, Berglen (DE); Patrick Schindler, Weilheim an der Teck (DE); Horst Otterbach, Waiblingen (DE)

(73) Assignee: Andreas Stihl AG & Co. KG, Waiblingen (DE)

(21) Appl. No.: 19/226,416

(22) Filed: Jun. 3, 2025

(30) Foreign Application Priority Data
Jun. 5, 2024 (DE) 102024115665.1

(51) Int. Cl. H02K 7/14; B23D 45/16; H02P 29/40

(52) U.S. Cl. CPC H02K 7/145; B23D 45/16; H02P 29/40

(57) ABSTRACT

A cut-off machine includes an electrical drive motor for driving a cutting tool. Provided in the cut-off machine is a control unit which supplies the drive motor with electrical power via a switching element. The control unit is connected to an actuator and changes the speed of the drive motor with the size and/or shape of the control signal. The control unit has a first and a second operating mode. In the first operating mode, depending on the control signal, the speed of the drive motor is supplied according to a first operating curve with a first maximum power and a first end speed. In a second operating mode, depending on the size of the control signal, the speed of the drive motor is supplied according to a second operating curve with a second maximum power and a second end speed.

### CROSS-REFERENCE TO RELATED APPLICATION

This application claims the benefit of German Patent Application DE 102024115665.1, filed on Jun. 5, 2024, the content of which is incorporated in its entirety.

### BACKGROUND

Cut-off machines, also known as cut-off saws or abrasive saws, are high-powered tools designed for quickly and precisely cutting through tough materials such as metal, concrete, asphalt, and masonry. These machines typically use a rotating abrasive wheel or diamond blade to perform clean and efficient cuts, making them essential for construction, demolition, rescue operations, and industrial maintenance.

### SUMMARY

The present application relates to a cut-off machine with an electrical drive motor for driving a cutting tool about an axis of rotation. A control unit is provided which supplies the electrical drive motor with electrical power for a speed via at least one switching element. The control unit is connected to a manually adjustable actuator which is configured to supply the control unit with a control signal which can change in size. The actuator is configured with a control path which extends between a first position of the actuator and a second position of the actuator. In the first position of the actuator, the control signal is in particular “0”, and, in a second position of the actuator, the control signal is, for example, increased to 100%. Depending on at least one travelled section of the control path, the size of the control signal changes, wherein at least the speed of the drive motor becomes greater with increasing size of the control signal.

In the case of an electrical cut-off machine, the actuator is to be operated by an operating element (throttle lever) which is arranged in an, in particular, rear handle of the cut-off machine. A user will usually push the operating element (throttle lever) all the way down in order to use the cut-off machine with maximum power and/or maximum speed.

If the electrical cut-off machine is intended to be used to make a precise cut and/or to produce an attractive cut pattern, this is often impossible or only very difficult to achieve at maximum speed. For example, if the intention is to cut to size painted tiles in which, for example, the base material is grey and the paint is white, the fewest possible breakouts, which would stand out in the colour of the base material, e.g. grey, should be visible on the painted surface after cutting. But even straight cuts or curved cuts with an attractive cut pattern are hard to achieve at high speeds and/or maximum power, as centrifugal forces and vibrations which occur hinder precise guidance of the cut-off machine.

To achieve a clean cut pattern or a precise cut, the user will try to adjust the speed with the operating element (throttle lever). To set a low operating speed, the operating element must not be fully pressed. Working with the cut-off machine with the operating element (throttle lever) only partially pressed down is tiring and does not always lead to the desired result. In particular, even slight changes in the position of the actuator can lead to significant speed changes, which are accompanied by vibrations and increased centrifugal forces.

The object underlying the disclosure is to configure a battery-powered electrical cut-off machine in such a way that the user can perform precise cuts with a clean cut pattern.

The object is achieved in that the control unit is configured to be operated in a first and at least a second operating mode. The control unit is configured, in the first operating mode, depending on the size of the control signal of the actuator, to control the speed of the drive motor according to a first operating curve with a first maximum power and a first end speed. The control unit is further configured, in the second operating mode, depending on the size of the control signal, to control the speed of the drive motor according to a second operating curve with a second maximum power and a second end speed.

Through this configuration of the cut-off machine with a control unit and at least two operating modes, the user is given the option of selecting the operating mode suitable for a cut. If the user selects, for example, the first operating mode with a low speed and a low power via an input unit, a clean and precise cut can be made even when the control element (throttle lever) is fully pressed down. The operating curve is specified to the control unit and limits the speed to a first end speed and/or a first power. Expediently provided on the housing of the cut-off machine is the input unit via which the user can select the desired operating mode that they need to make a cut. The input unit may also be a wireless input unit.

The first and the second operating curves are determined by specified parameters such as, for example, gradient, maximum values, minimum values and/or curve points. The parameters of the operating curves are preferably stored. In particular, an operating curve memory which is connected to the control unit is provided for this. The operating curves with discrete operating points or algorithms can be stored in the operating curve memory.

The first and the second operating curves each have a power plateau. The respective power plateau has a specified, in particular constant, power. The power of the power plateau of the first operating curve is smaller than the power of the power plateau of the second operating curve. The power of the first power plateau may lie between 2,000 watts and 3,000 watts. The power of the second power plateau may lie between 2,600 watts and 3,800 watts. The power of a third power plateau of an, in particular, third operating curve may lie between 3,600 watts and 5,000 watts and may correspond to the maximum power of the drive unit.

The curve sections rising against the speed to the power plateau of the first operating curve of the first operating mode and to the power plateau of the second operating curve of the second operating mode have different gradients. The gradient of the curve section to the power plateau of the first operating curve is smaller than the gradient of the curve section to the power plateau of the second operating curve here. This also means that, with an increasing control path of the actuator, the speed of the first operating curve rises more slowly than the speed of the second operating curve. The operating curves are configured such that the first end speed of the first operating curve is smaller than the second end speed of the second operating curve.

It may be advantageous to provide a third operating mode with a third operating curve. The third operating curve of the third operating mode is also stored in an operating curve memory connected to the control unit. In particular, the third operating curve has a maximum gradient and a maximum (third) end speed.

In a refinement, provision is made for the manual actuator to be configured as a potentiometer, in particular to be configured as a digital potentiometer. Other types of actuators may also be expedient.

The electrical cut-off machine is supplied by a battery which provides the electrical power needed to operate the drive motor. In a refinement, provision is made for the control unit to be configured such that it can record the power and/or the capacity of the battery inserted in the cut-off machine. The recognized power and/or capacity of the battery can be used to limit the selection of the operating mode depending on the size of the capacity and/or the power of the inserted battery. For example, the third operating curve may be locked and not selectable if a battery with insufficient capacity is inserted.

The control path of the actuator has a first setting section and at least a second setting section. The speed of the drive motor increases in the first setting section of the actuator to the end speed of the operating mode. The configuration of the operating modes is provided such that the first setting section of the first operating curve in the first operating mode is longer than the first setting section of the second operating curve in the second operating mode.

It may be advantageous for the first setting section in the first operating mode to correspond to 70% to 80% of the total control path of the actuator. The first setting section in the second operating mode advantageously corresponds to 50% to 70% of the total control path of the actuator. In a third operating mode, the first setting section corresponds to approximately 25% to 35% of the total control path.

Further features of the invention are disclosed in the claims, the following description and the drawing. The features disclosed in the claims, the following description and the drawing can be combined with one another as desired.

An exemplary embodiment of the invention is shown in the drawings and is described in detail below.

### BRIEF DESCRIPTION OF THE DRAWINGS

FIG. 1 shows a side view of a battery-operated electrical cut-off machine,

FIG. 2 shows a schematic representation of the control unit installed in the cut-off machine for operation in different operating modes,

FIG. 3 shows a diagram of the power plotted against the speed of different operating curves of the various operating modes,

FIG. 4 shows a diagram of the speed plotted against the control path of the actuator in different operating modes.

### DETAILED DESCRIPTION

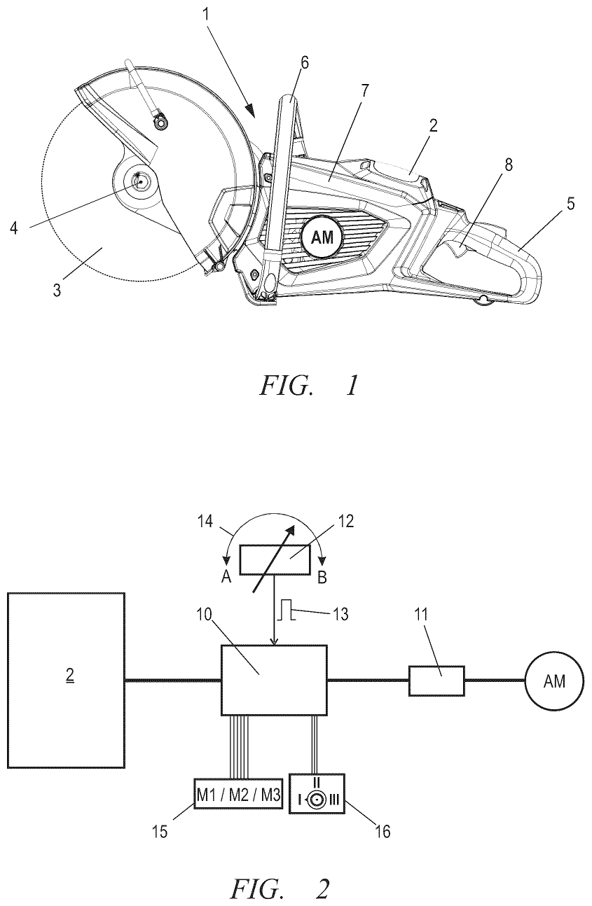

FIG. 1 shows an electrical cut-off machine 1 which is supplied with electrical power from a battery 2. The battery 2 is inserted over a large part of its length into the housing 7 of the cut-off machine 1. The electrical drive motor AM of the cut-off machine 1 drives a cutting tool 3 rotating about an axis of rotation 4. The cut-off machine 1 is guided and held by a user with a rear handle 5 and a front bow handle 6. In particular, an control element 8 (throttle lever) is held in the rear handle 5. The control element 8 is mechanically coupled to an electrical actuator 12 (FIG. 2). Swivelling (pressing down) the control element 8 (throttle lever) causes an adjustment of the actuator 12 which changes the size and/or shape of a control signal 13 depending on a control path followed.

Accommodated in the housing 7 of the cut-off machine is a control unit 10, which is reproduced in a schematic block diagram in FIG. 2. The control unit 10 is configured to supply the drive motor AM with the power needed for operation from the battery 2 via at least one switching element 11. For this purpose, the control unit 10 is connected, on the one hand, to the battery 2 and, on the other, to the switching element 11 which is connected to the drive motor AM. The switching element 11 may be an electromechanical switching element; in particular, the switching element 11 is an electronic switching element, such as, for example, a power transistor, a thyristor, a MOSFET or the like.

The control unit 10 is connected to the actuator 12 which is manually adjustable by the control element 8. The actuator 12 is configured to supply the control unit 10 with a control signal 13 which can change in size and/or shape. The electrical power P supplied to the drive motor AM via the switching element 11 or the speed n of the drive motor AM depends on the size and/or shape of the control signal 13. Preferably, the speed n of the drive motor AM rises or the electrical power P supplied to the drive motor AM grows with an increasing size of the control signal 13.

The manual actuator 12 is configured with a control path 14 which extends between a first position A of the actuator 12 and a second position B of the actuator 12. The position A of the actuator 12 corresponds, for example, to a zero position with a size of the control signal 13 of “0”; the position B of the actuator 12 corresponds, for example, to an end position with a size of the control signal 13 of, for example, 100%. The size of the control signal 13 increases depending on at least one travelled section of the control path 14 from the first position A to the second position B. In the opposite direction, the size of the control signal 13 decreases depending on at least one travelled section of the control path 14 from the second position B to the first position A. The speed of the drive motor AM can be changed with the actuator 12.

The control unit 10 is configured such that it has a first operating mode M1 and at least a further, second operating mode M2. Advantageously, the control unit 10 is configured such that a third operating mode M3 for operating the cut-off machine 1 is also provided.

At least the first and the second operating curves are determined by specified parameters. These parameters may be individual operating points or else set by a functional equation. These parameters, in particular a specific operating curve, are stored in an operating curve memory 15. The operating curve memory 15 is electrically connected to the control unit 10. The control unit 10 can call up the different operating curves of the operating modes M1, M2 and/or M3 from the operating curve memory 15. The selection of the corresponding operating mode M1, M2 or M3 is made through an input unit 16, which is shown schematically in FIG. 2 as a rotary selector. The input device may also be configured as a touch display, through individual switches or the like.

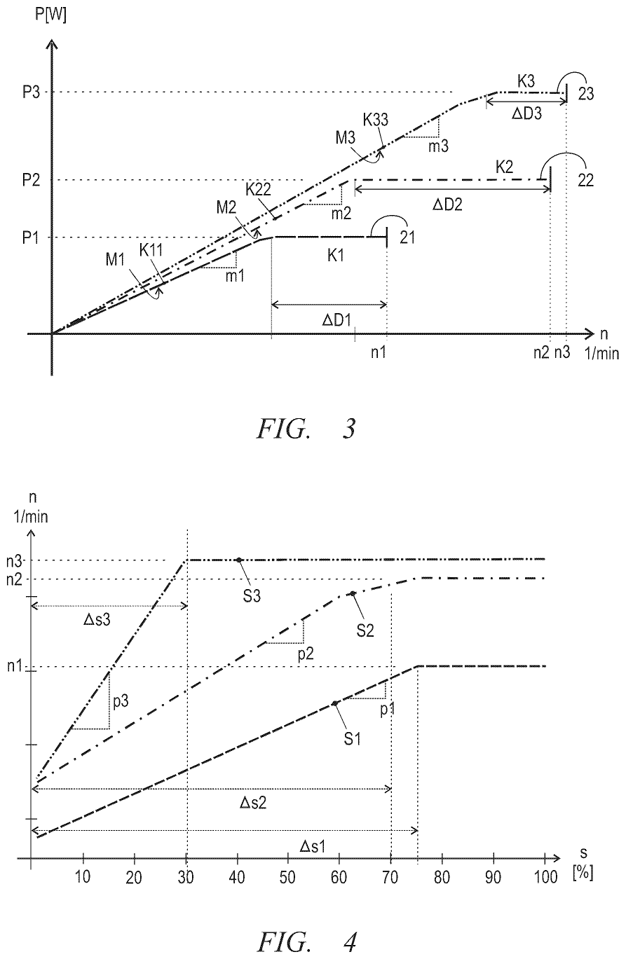

FIG. 3 shows different operating curves K1, K2 and K3 of various operating modes M1, M2 and M3. The operating curves K1, K2 and K3 are shown as curves of the power P in watts plotted against the speed n in 1/min.

A first operating curve K1 of the first operating mode MI has a first maximum power P1 and a first end speed n1. The maximum power P1 lies on a power plateau 21 which is constant, in particular, in terms of power P, above a speed window ΔD1. In particular, the first maximum power P1 is 2,400 watts. In particular, the first end speed n1 is 8,000 1/min.

A second operating curve K2 of the second operating mode M2 has a second maximum power P2 and a second end speed n2. The maximum power P2 lies on a power plateau 22 which is constant, in particular, in terms of power P, above a speed window ΔD2. In particular, the maximum power P2 is 3,800 watts. In particular, the second end speed n2 is 9,700 1/min.

A third operating curve K3 of the third operating mode M3 has a third maximum power P3 and a third end speed n3. The maximum power P3 lies on a power plateau 23 which is constant, in particular, in terms of power P, above a speed window ΔD3. In particular, the maximum power P3 is 5,000 watts. In particular, the third end speed n2 is 10,000 1/min.

Based on a starting speed, in particular a starting speed of “zero”, the respective power plateau 21, 22, 23 is achieved via rising curve sections K11, K22, K33 respectively. The rising curve sections K11, K22, K33 each have different gradients m1, m2 and m3 here.

The curve section K11 rising to the first power plateau 21 of the first operating curve K1 has the gradient m1. The curve section K22 rising to the second power plateau 22 of the second operating curve K2 has the gradient m2. The curve section K33 rising to the third power plateau 23 of the third operating curve K3 has the gradient m3.

As can be seen in FIG. 3, the gradient m1 of the rising curve section K11 is smaller than the gradients m2 and/or m3 of the rising curve sections K22 and K33 of the second and/or the third operating curves K2 and K3. The gradient m3 of the rising curve section K33 has the largest gradient. The gradient m2 lies between the smallest gradient m1 and the largest gradient m3. The following equation applies: m1<m2<m3.

In a particular refinement, provision is made for a changed characteristic of the control signal 13 to be assigned to each operating curve K1, K2 and/or K3. FIG. 4 shows various control curves S1, S2 and S3 as speed n [1/min] over the control path s [%]. The end speed n1 of the first operating curve K1 is only achieved if the actuator 12 has travelled, in particular, 70% to 80%, very particularly 75% of the control path 14. Only in the last 20% to 30% of the control path 14, in particular 25% of the control path 14, is the speed at n1 achieved as the end speed. The rise in speed over the control path Δs1 of the control curve S1 has a gradient p1. The user can press down the control element 8 (throttle lever) over 70% to 80% before the first end speed n1 of the first operating curve K1 is reached.

The control curve S2 of the second operating curve K2 is interpreted correspondingly. The second end speed n2 of the second operating curve K2 is greater than the end speed n1 of the first operating curve K1. The rise in speed over the setting section Δs2 of the control curve S2 has a gradient p2. The user can press down the control element 8 (throttle lever) over up to 70% before the second end speed n2 of the second operating curve K2 is reached. The rise in speed is steeper than in the case of the first control curve S1 of the first operating curve K1.

The control curve S3 of the third operating curve K3 has a third end speed n3 which is greater than the end speed n2 of the second operating curve K2 and/or the end speed n1 of the first operating curve K2. The rise in speed over the setting section Δs3 of the control curve S3 has a gradient p3. The user can press down the control element 8 (throttle lever) by 30% and already reaches over this setting section Δs3 the third end speed n3 of the third operating curve K3.

By selecting an operating curve K1, K2 or K3 (FIG. 3), the latter is in each case assigned a selected characteristic of the actuator 12 according to the control curves S1, S2 and S3 (FIG. 4). The control curve S1 is assigned to the operating curve K1 so that the user can finely vary the speed and, owing to the limit on the power P1 and the reduced end speed n1, can make a clean cut in a material. The operating curve K2 is assigned the control curve S2 with which, over approximately the same setting section Δs2 as in the control curve S1, the speed can increase finely to the second end speed n2 starting from a starting speed. If maximum power is required, the operating curve K3 with the control curve S3 with which the end speed n3 is already reached over a setting section of 30% is selected.

What is claimed is:

1. A cut-off machine, comprising:
a cutting tool (3);
an electrical drive motor (AM) for driving the cutting tool (3) about an axis of rotation (4); and
a control unit (10) configured to supply the electrical drive motor (AM) with electrical power (P) for a speed (n) via at least one switching element (11),
wherein the control unit (10) is connected to a manual actuator (12),
wherein the manual actuator (12) is configured to supply the control unit (10) with a control signal (13),
wherein the control signal (13) can change in size and/or shape,
wherein the manual actuator (12) is configured with a control path (14),
wherein the control path (14) extends between a first position (A) of the manual actuator (12) and a second position (B) of the manual actuator (12),
wherein the size and/or shape of the control signal (13) changes from the first position (A) to the second position (B) of the manual actuator (12) depending on at least one travelled section of the control path (14), and
wherein the speed (n) of the electrical drive motor (AM) changes with the size and/or shape of the control signal (13),
wherein the control unit (10) has a first operating mode (M1) and at least a second operating mode (M2), and
wherein the control unit (10) is configured, in the first operating mode (M1), depending on the control signal (13), to control the speed (n) of the electrical drive motor (AM) according to a first operating curve (K1) with a first maximum power (P1) and a first end speed (n1), and
wherein the control unit (10) is configured, in the second operating mode (M2), depending on the control signal (13), to control the speed (n) of the electrical drive motor (AM) according to a second operating curve (K2) with a second maximum power (P2) and a second end speed (n2).

2. The cut-off machine according to claim 1,
wherein the first operating curve (K1) and the second operating curve (K2) are determined by specified parameters.

3. The cut-off machine according to claim 1,
wherein the first operating curve (K1) and the second operating curve (K2) each have a power plateau (21, 22) with a specified power (P1, P2).

4. The cut-off machine according to claim 1,
wherein curve sections (K11, K12) rising to respective power plateaus (21, 22) of the first operating curve (K1) and the second operating curve (K2) have different gradients (m1, m2).

5. The cut-off machine according to claim 4,
wherein a first gradient (m1) of a first of the curve sections (K11) to a first of the respective power plateaus (21) of the first operating curve (K1) is smaller than a second gradient (m2) of a second of the curve sections (K22) to a second of the respective power plateaus (22) of the second operating curve (K2).

6. The cut-off machine according to claim 1,
wherein the first end speed (n1) of the first operating curve (K1) is smaller than the second end speed (n2) of the second operating curve (K2).

7. The cut-off machine according to claim 6,
wherein the cut-off machine (1) comprises a control element (8) for operating the manual actuator (12),
wherein the first maximum power (P1) of the first operating curve (K1) is smaller than the second maximum power (P2) of the second operating curve (K2),
so that, if a user selects the first operating mode (M1) with a small first end speed (n1) and a small first maximum power (P1) via an input unit (16), a clean and precise cut can be made even when the control element (8) is fully pressed down.

8. The cut-off machine according to claim 1,
wherein in a third operating mode (M3), a third operating curve (K3) is specified, and the third operating curve (K3) is stored in an operating curve memory (16) connected to the control unit (10).

9. The cut-off machine according to claim 8,
wherein the third operating curve (K3) has a maximum gradient (m3) and a maximum end speed (n3).

10. The cut-off machine according to claim 1,
wherein the manual actuator (12) is a potentiometer.

11. The cut-off machine according to claim 1,
wherein the electrical power (P) is provided by a battery (2).

12. The cut-off machine according to claim 11,
wherein the electrical power and/or a capacity of the battery (2) is detected by the control unit (10).

13. The cut-off machine according to claim 12,
wherein a selection of the first operating mode (M1) or the second operating mode (M2) is made depending on the electrical power and/or the capacity of the battery (2).

14. The cut-off machine according to claim 1,
wherein the control path (14) of the manual actuator (12) comprises a first setting section (Δs1) and at least a second setting section,
wherein the speed (n) of the electrical drive motor (AM) in the first setting section (Δs1) increases to the first end speed (n1) of the operating mode (M1), and
wherein, in the first operating mode (M1), the first setting section (Δs1) is longer than a first setting section (Δs2) in the second operating mode (M2).

15. The cut-off machine according to claim 14,
wherein the first setting section (Δs1) in the first operating mode (M1) corresponds to 70% to 80% of a total of the control path (14) and the first setting section (Δs2) in the second operating mode (M2) corresponds to 50% to 70% of the total of the control path (14).

16. The cut-off machine according to claim 14,
wherein in a third operating mode (M3), a third operating curve (K3) is specified, and
wherein the first setting section (Δs3) in the third operating mode (M3) corresponds to 25% to 35% of a total of the control path (14).
